(19) United States
(12) Patent Application Publication
(10) Pub. No.: US 2006/0170944 A1
(43) Pub. Date: Aug. 3, 2006

(54) Method and system for rasterizing and encoding multi-region data

(76) Inventors: Ronald B. Arps, Stanford, CA (US); Jean M. Aschenbrenner, Boulder, CO (US); Mihail C. Constantinescu, San Jose, CA (US); Jennifer Q. Trelewicz, Gilroy, CA (US); Rose E. Visoski, Louisville, CO (US)

Correspondence Address: DUFT BORNSEN & FISHMAN, LLP, 1526 SPRUCE STREET, SUITE 302, BOULDER, CO, 80302, US

(21) Appl. No.: 11/047,968

(22) Filed: Jan. 31, 2005

(51) Int. Cl. G06F 3/12

(52) U.S. Cl. 358/1.13

(57) ABSTRACT

System and method for rasterizing and encoding multi-region data. In one aspect, a rasterizer derives descriptive information from print data stream (PDS) data, where the descriptive information includes a designation of at least one region of text data in the PDS data, and bitmap data depicting the region of text data. The bitmap data is provided to an encoder without including the bitmap data in a rasterized page bitmap of the PDS data, and the bitmap data is encoded into compressed data using the encoder and a compression format suitable for text data. In another aspect, regions of data are compressed using descriptive information provided from a rasterizer to an encoder via an application program interface

### FIELD OF THE INVENTION

The present invention relates to encoding and decoding of data, and more particularly to the rasterizing and encoding of multi-region data.

### BACKGROUND OF THE INVENTION

Encoding techniques and systems allow data to be compressed, i.e., reduced in bandwidth and storage requirements so that the data can be stored, displayed, printed, transmitted, or otherwise manipulated with greater speed and ease. In display and printing applications, for example, compression is often used to reduce the bandwidth requirements of rasterized bitmap data, since large or page-sized bitmaps, uncompressed, can take a large amount of storage space or communication bandwidth. For example, compressed rasterized data can be quickly transmitted to the appropriate output devices over buses or other communication channels having low bandwidth. Furthermore, encoding and compression is useful to reduce the storage requirements of the data once at the output device, so that the data may be more easily cached in limited memory space or storage space before it is displayed or printed. Compression is also useful within an output device when sending or manipulating the data to the output components of a device, e.g. the print head or mechanism on a printer.

High compression ratios are achieved in various ways, and can be either lossless, so that no original data is lost after decompression, or lossy, in which some data may be lost. In one efficient lossless encoding technique, symbolic representation is used to compress data in a structured format, such as data provided in a page description language (PDL). In one existing symbolic compression technique for rasterized text data, data in a PDL format is provided, which is data encoded in a particular format useful for storing data in a form appropriate for displaying or printing. For example, the PDL format can be Postscript or Portable Document Format (PDF) provided by Adobe Systems, Inc., or Intelligent Printer Datastream (IPDS) from IBM Corporation. The PDL data is rasterized into a page bitmap, bitmap shapes in the page bitmap are extracted, and repeating shapes are represented by a single bitmap “token” provided in a symbol dictionary. The tokens are “pseudo-symbols” in the sense that they are not recognized as particular characters or symbols, but they are matched to recurring shapes in a document in a symbol-like manner. In this way, substantial compression can be achieved, since only one of each bitmap shape (the token) need be stored, while only an identifier and location of the other matching repeating shapes need be stored, which take much less storage space than storing the bitmaps. In data or documents in which the same shapes are often repeated, such as characters in a text document, the compression achieved using this method can be substantial. Furthermore, since the actual bitmaps are being stored in the dictionary and provided in the decompressed bitmap, no loss in quality or errors in symbol recognition are possible.

One problem with this technique of providing compression using tokens is that the analyzing of the page bitmap, the extracting of shapes from the bitmap, and the matching of extracted shapes with tokens stored in the dictionary can take a significant amount of time. For uses requiring a very fast print or display rate, this technique may be too slow. For example, speed is of critical importance in systems such as production printers, where pages may need to be raster-processed, stored, and printed at more than 1000 ipm (images per minute). Some compression techniques may allow direct compilation, where a non-standard rasterizer is closely and directly coupled to an encoder, such that no intermediate page bitmap is produced and thus no analysis, extraction, or matching need be performed to create the compressed data. However, this implementation requires that a non-standard rasterizer and encoder be implemented for every format of the Print Data Stream (PDS) data desired to be processed, which may be too burdensome. It is more cost-effective and practical to separate the rasterizer from the encoder, i.e., make them independent, since only one encoder then need be provided.

The prior techniques of compression may also be too slow or inefficient for other reasons, including reasons related to the use of multiple types of data on a single page. Many PDLs allow different types of data, including text, line-art graphics, and bitmap images, to be provided on a single page, each type of data in a different “region” of the page. Some compression techniques (or compression “toolkits”) allow different compression formats or methods to be used for different regions on a page. For example, the Joint Bilevel Image Experts Group 2 (JBIG2) standard can be used for lossy and lossless compression of bi-level (bitonal) images, e.g. images comprised only of one color, such as black, on a background color, such as white, and can code and integrate both scanned and generated bi-level images. It can achieve compression ratios of several times other standards, since it can tailor each region's compression with a compression format suitable for that type of data. For example, the JBIG2 standard uses symbolic representation in text regions (as described above) and arithmetic coders in some types of image regions (such as “generic” regions, in which the data type is unknown or of multiple types).

However, one problem with multi-region compression is that page bitmaps must be analyzed to find the multiple types of data on the page and segmented into regions, which can be time-consuming as well as inaccurate. Furthermore, segmentation technology is currently an area of active research, and effective segmenters tend to run more slowly than many popular compression algorithms. Therefore, multi-region encoders or compression toolkits such as JBIG2 typically do not provide such segmentation processing. In some implementations, segmentation information can be provided to the encoder from an outside process; in others, segmentation is ignored. In many JBIG2 implementations, a JBIG2 encoder receives an entire page bitmap from a rasterizer and applies a “generic” kind of encoding on the entire page, ignoring different regions and treating them the same. This method, however, obviously ignores the superior compression that can be achieved with tailored compression formats, such as symbolic representation used for text regions.

Accordingly, what is needed is an apparatus and method for fast rasterization and compression for multi-region data, in which regions are compressed appropriately for their type. The present invention addresses such a need.

### SUMMARY OF THE INVENTION

The invention of the present application relates to a system and method for rasterizing and encoding multi-region data. In one aspect of the invention, a method for rasterizing and encoding data includes deriving descriptive information from print data stream (PDS) data, the PDS data describing output for an output device, where the descriptive information includes a designation of at least one region of text data in the PDS data, and bitmap data depicting the at least one region of text data. The bitmap data is provided to an encoder without including the bitmap data in a rasterized page bitmap of the PDS data, and the bitmap data is encoded into compressed data using the encoder and a compression format suitable for text data, the compressed data depicting the at least one region of text data. Similar aspects of the invention provide a system and computer readable medium for implementing similar features.

In another aspect of the invention, a method for rasterizing and encoding data includes deriving descriptive information from print data stream (PDS) data using a rasterizer, the PDS data describing output for an output device, where the descriptive information includes a description of at least one region of data in the PDS data. Bitmap data is produced which is derived from the PDS data and includes the at least one region of data, the bitmap data produced using the rasterizer. The descriptive information is provided from the rasterizer to an encoder via a general application program interface (API) allowing communication between the rasterizer and the encoder, and the bitmap data is encoded into compressed data using the encoder, the bitmap data derived from the PDS data, where the descriptive information is used in the encoding to determine a compression format suitable for the at least one region in the bitmap data.

In another aspect of the invention, a method for rasterizing data to be encoded includes deriving descriptive information from print data stream (PDS) data, the PDS data describing output for an output device, where the descriptive information includes a description of at least one text region of data in the PDS data. The PDS data is rasterized into additional descriptive information including bitmap data depicting the at least one text region, wherein the bitmap data is not included in a rasterized page bitmap of the PDS data. The descriptive information and the additional descriptive information is provided to an encoder so that the encoder can use the descriptive information when encoding the bitmap data into compressed data, where the descriptive information is used to determine a compression format suitable for the at least one text region depicted by the bitmap data. Similar aspects of the invention provide a computer readable medium and a rasterizer providing similar features.

In another aspect of the invention, a method for encoding data includes receiving descriptive information from a rasterizer, the descriptive information derived from print data stream (PDS) data describing output for an output device. The descriptive information includes a description of at least one text region of data in the PDS data and bitmap data depicting the at least one text region of data, wherein the bitmap data is not included in a rasterized page bitmap of the PDS data. The bitmap data is encoded into compressed data, where the descriptive information is used in the encoding to determine a compression format suitable for the bitmap data depicting the at least one text region of data. Similar aspects of the invention provide a computer readable medium and an encoder providing similar features.

The present invention allows very fast and efficient compression of multi-region bitmap data such as page bitmaps. Features of structured incoming data can be determined by a rasterizer and fed directly to a multi-region encoder, such as JBIG2, which can use the features to quickly segment and compress different regions according to appropriate compression formats to achieve superior compression ratios. Furthermore, the rasterizer and encoder can be independent of each other, communicating via a common interface such as an API, thus allowing much greater flexibility in providing the rasterizing/encoding system.

### BRIEF DESCRIPTION OF THE FIGS.

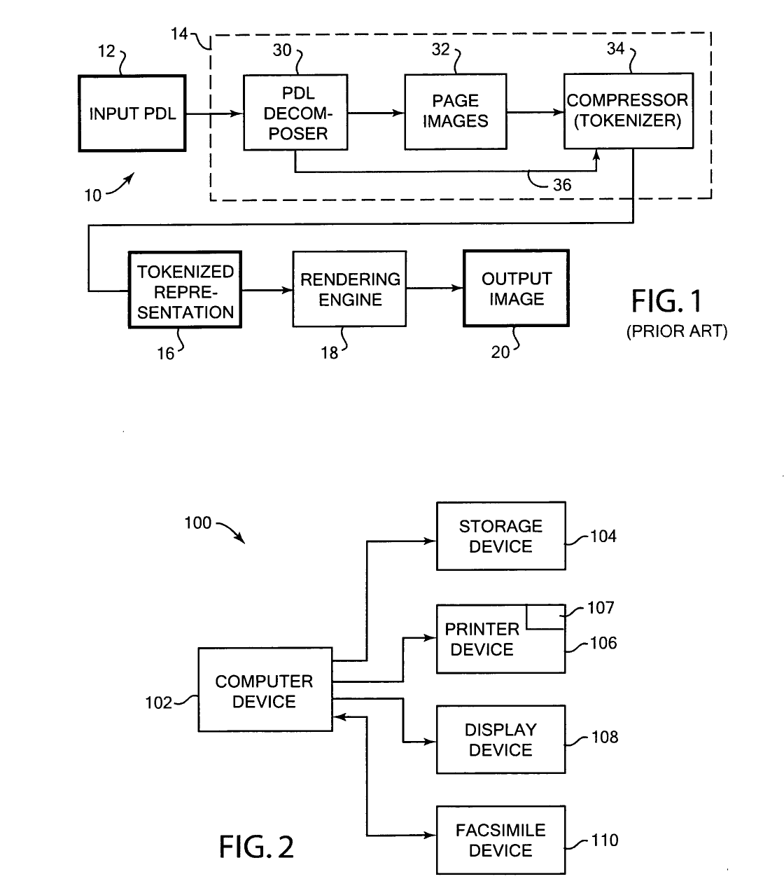

FIG. 1 is a block diagram illustrating a prior art system for symbolic text compression of data rasterized from page description language (PDL) data;

FIG. 2 is a block diagram illustrating a hardware system suitable for use with the present invention;

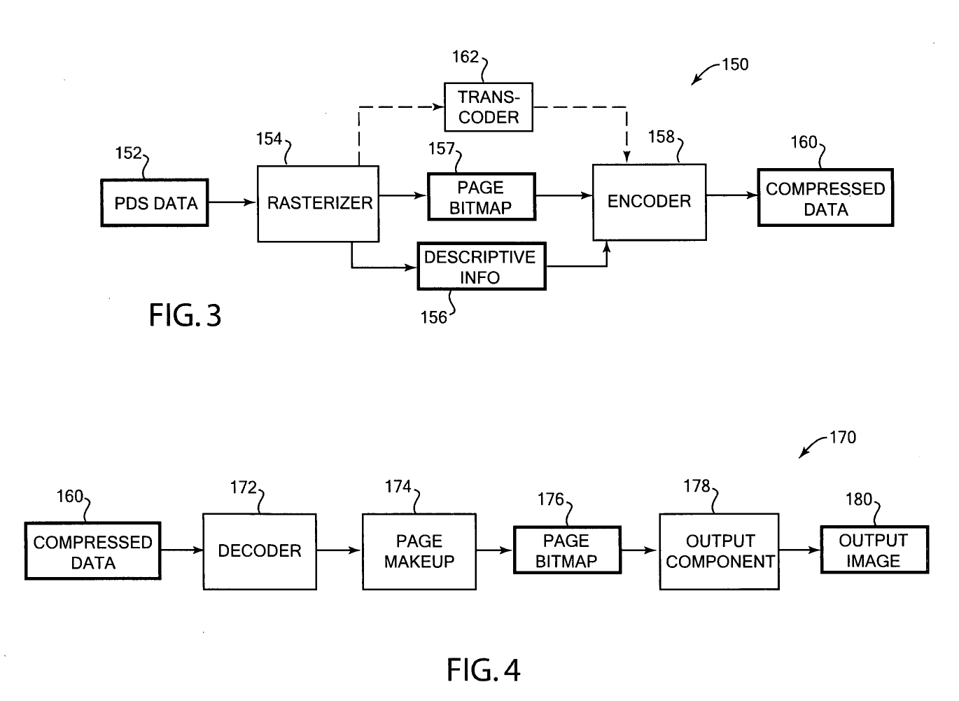

FIG. 3 is a block diagram illustrating a rasterizing and encoding system of the present invention;

FIG. 4 is a block diagram illustrating a decompression and output system of the present invention;

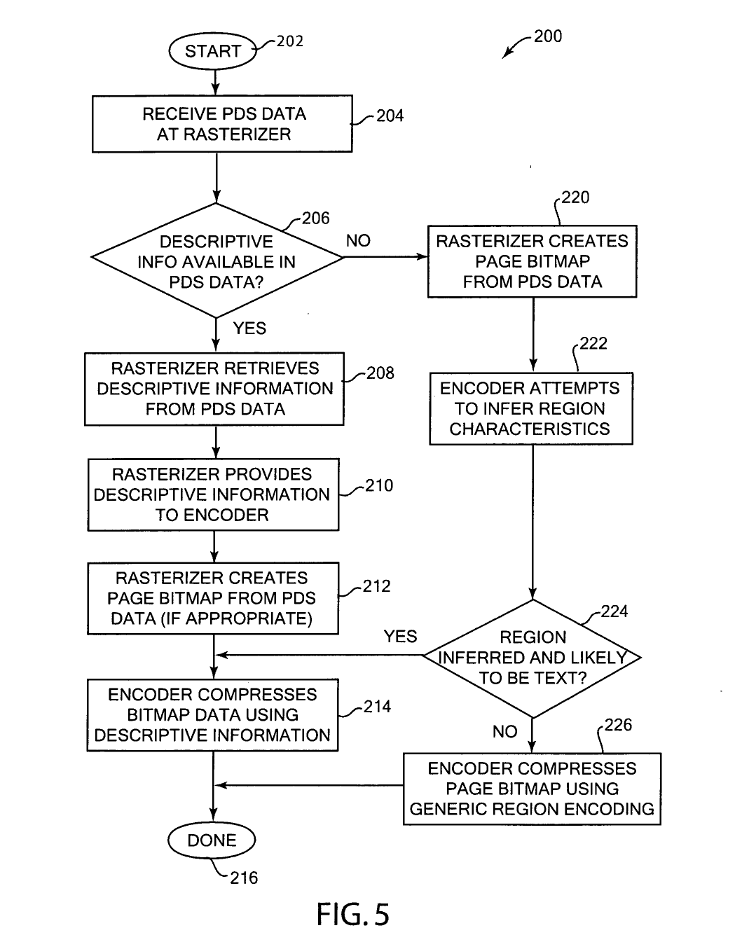

FIG. 5 is a flow diagram illustrating a method of the present invention for rasterizing and encoding multi-region data;

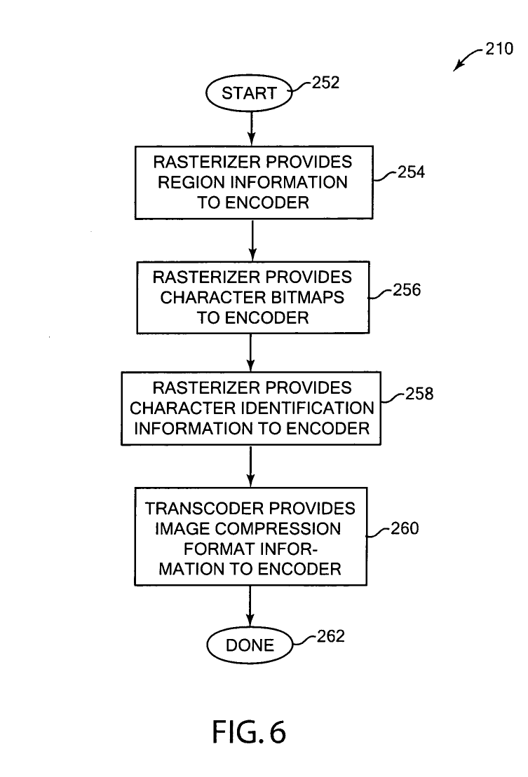

FIG. 6 is a flow diagram illustrating a step of FIG. 5, in which the rasterizer provides descriptive information to the encoder;

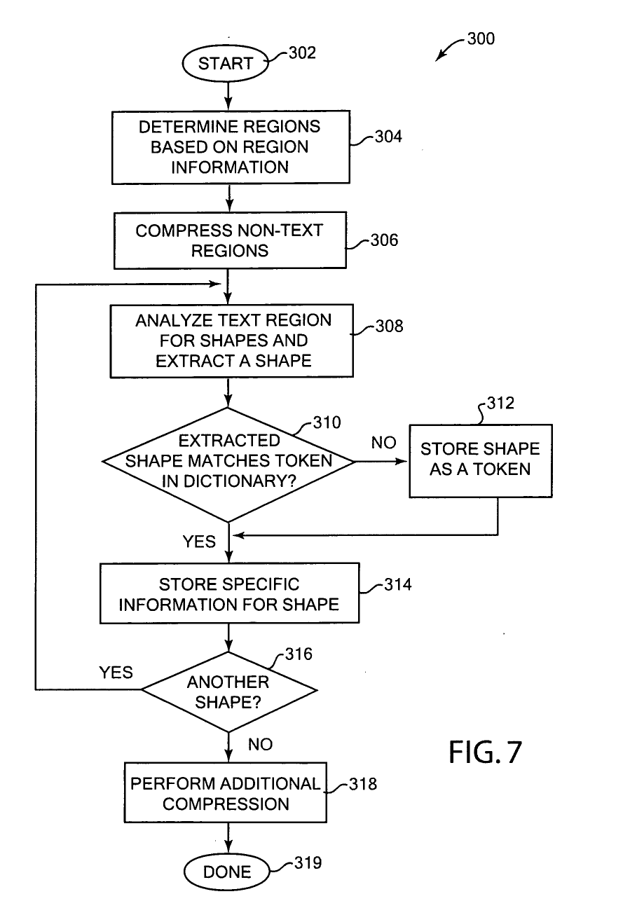

FIG. 7 is a flow diagram illustrating a process of data compression used by the encoder of the present invention in which the encoder has received region information from the rasterizer;

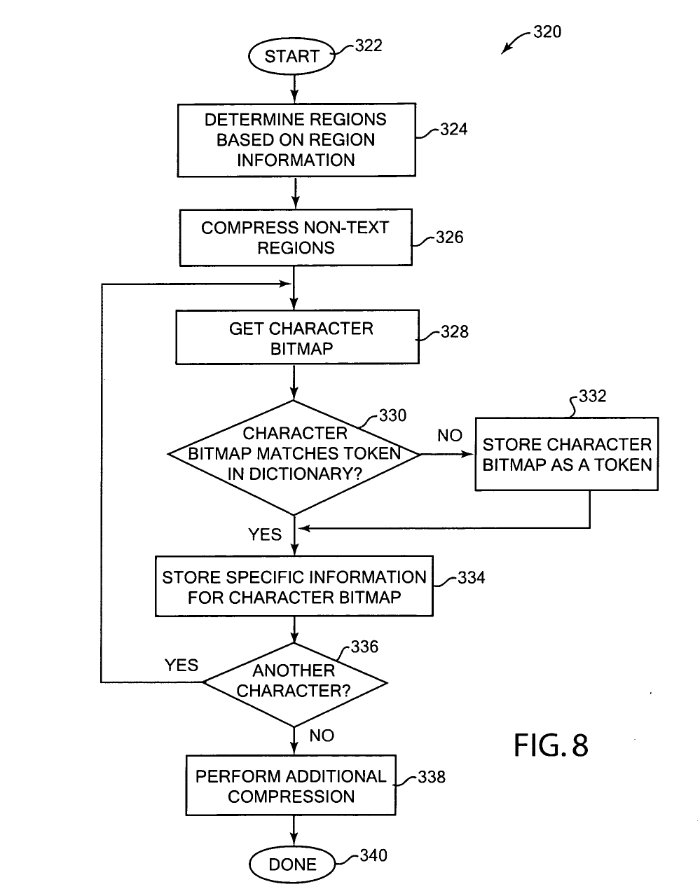

FIG. 8 is a flow diagram illustrating a process of data compression used by the encoder of the present invention, in which the encoder has received region information and character bitmaps from the rasterizer;

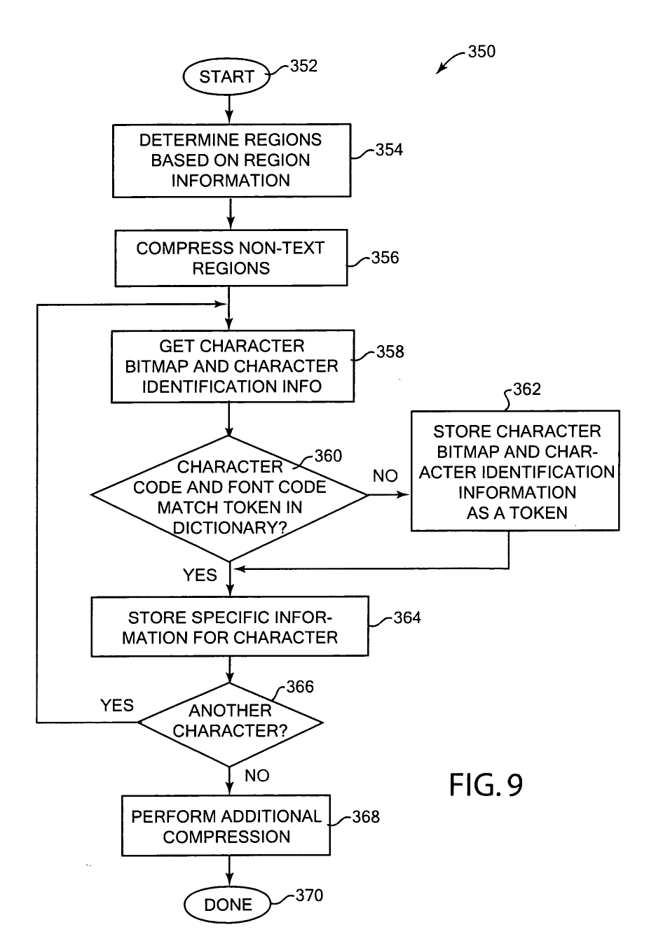

FIG. 9 is a flow diagram illustrating a process of data compression used by the encoder of the present invention, in which the encoder has received region information and character identification information from the rasterizer;

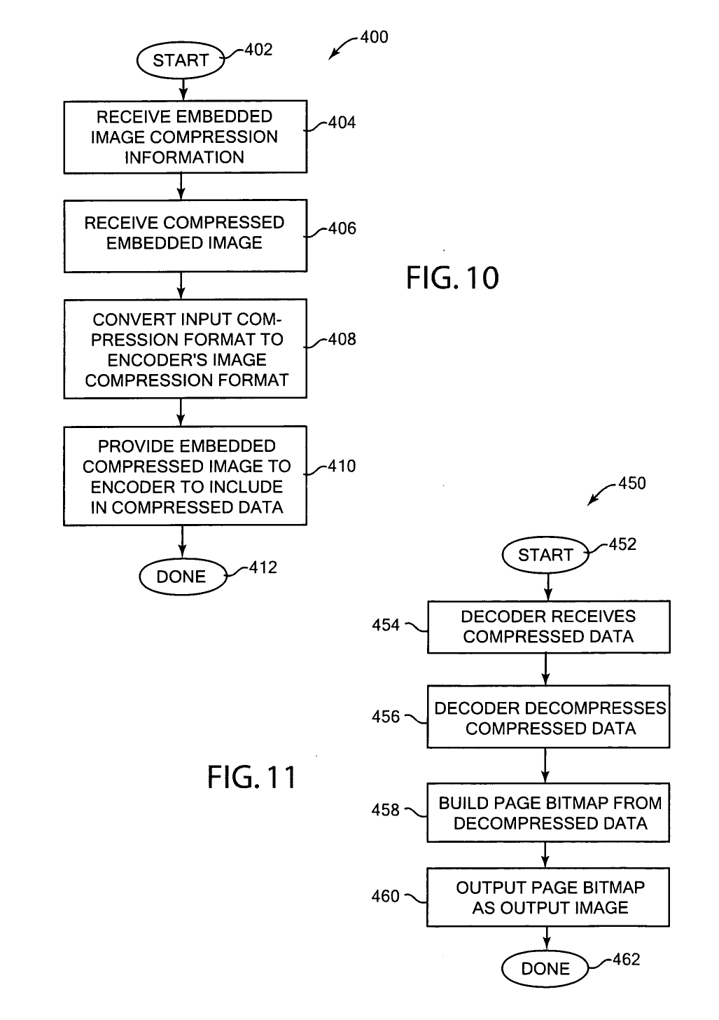

FIG. 10 is a flow diagram illustrating a process of the present invention to compress an embedded compressed image, where compressed image format information has been received from the rasterizer; and

FIG. 11 is a flow diagram illustrating the decoding process of the present invention.

### DETAILED DESCRIPTION

The present invention relates to encoding and decoding of data, and more particularly to the rasterizing and encoding of multi-region data. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular systems provided in particular implementations. However, one of ordinary skill in the art will readily recognize that this method and system will operate effectively in other implementations. For example, the processing systems and output devices usable with the present invention can take a number of different forms. The present invention will also be described in the context of particular methods having certain steps. However, the method and system operate effectively for other methods having different and/or additional steps not inconsistent with the present invention.

To more particularly describe the features of the present invention, please refer to FIGS. 1 through 11 in conjunction with the discussion below.

FIG. 1 is a block diagram illustrating a system 10 of the prior art used for symbolic compression of data rasterized from page description language (PDL) data. Such a system is described more fully in U.S. Pat. No. 5,884,014.

An input PDL representation 12 of a document is provided, such as a PostScript file. The PDL representation is input to a tokenizing compiler 14, which interprets the PDL representation and produces a tokenized representation 16 of at least one portion of the document (some regions of the document may not be tokenized). The tokenized representation 16 is input to a decompressor and rendering engine 18, which renders a page bitmap image from the tokenized representation 16 and outputs the rendered image as an output image representation 20 using an output device, such as a display screen, image output terminal, etc.

The tokenizing compiler 14 produces the tokenized representation 16 from the PDL representation 12 by using a PDL decomposer 30, which receives the PDL representation 12 and produces page images 32 which are page bitmaps stored in a page images buffer. The tokenizer 34 then analyzes the page images to identify shapes therein, and then matches extracted shapes to tokens stored in a dictionary, where multiple occurrences of the same shape are assigned to a single token, and the location and identification of extracted shapes are stored. In this way, compression is achieved, since only a single bitmap token for each recurring shape need be stored. The token dictionary, location information, and any other needed information are stored in a predetermined format which the decompressor and rendering engine 18 can recognize and process into the original page image 32 at the appropriate stage.

As noted previously, in this type of prior art system, the analyzing of the page bitmap, the extracting of shapes from the bitmap, and the matching of extracted shapes with tokens stored in the dictionary can take a significant and burdensome amount of time. Furthermore, direct compilation techniques that couple a non-standard rasterizer to an encoder require that a different encoder be implemented for every format of the PDL data desired to be processed, which may not be practical.

FIG. 2 is a block diagram of a hardware system 100 of the present invention. System 100 can include a number of components, including a computer device 102 and one or more peripheral devices, including a storage device 104, a printer device 106, a display device 108, and a facsimile device 110. Various other output devices and other components can be included as desired, which are not shown.

Computer device 102 can be any electronic processor or device that is able to store and/or provide data to the other components of the system 100. For example, computer device 102 can be a desktop computer, workstation, or other general-purpose computer, or a network server or print server. Alternatively, the computer device 102 can be a portable computer, electronic device or controller, mainframe computer, etc. One or more microprocessors and memory of the computer device 102 can implement applications and/or other programs which perform operations such as generating a document, providing a print data stream (PDS) to be output to one or more of the peripheral devices, and perform other needed computations or data storage. The computer system 102 can include one or more processors (microprocessors, application specific integrated circuits, etc.), memory (RAM and/or ROM), and input/output (I/O) components (network interface, input devices such as a keyboard, stylus, mouse, microphone, scanner, etc.), as is well known.

Storage device 104 can be coupled to computer device 102 to store data that is sent or retrieved by computer device 102. Storage device 104 can be any such device, including a hard disk drive, non-volatile memory, CD-ROM drive, DVD-ROM drive, magnetic tape, or other optical or magnetic storage devices. Some storage devices are often provided in the same housing as computer device 102, while others may be accessed by the computer device 102 over a computer network. Storage device 104, for example, can store data compressed by the invention which is to be retrieved and output at a later time.

Printer device 106 is coupled to the computer device 102 and is used to provide output on a print medium such as paper, plastic, or other suitable material. Printer device 106 can be any of a variety of printing devices, including a laser printer, ink printer (inkjet, dot matrix, etc.), thermal printer, copier, etc. In the context of the present invention, the printer device 106 can be a raster display device that is able to print output based on a bitmap by printing dots in accordance with the pixels of a page bitmap, as is well-known in the art. Some types of printer devices are bitonal, in that they can print only two levels of output, e.g., black and white, where black is the printed ink or toner, and white is the lack of such ink or toner on a white paper. Other printer devices may output many colors or shades of grey.

The printer device 106 can receive commands and data from computer device 102 (or other sources) and print indicated data. The printer device 106 may also send status signals or data to the computer device 102. The printer device 106 can create printed text and/or images using any well-known technique. For example, many bitonal printer devices are able to print halftone images, in which the sizes of dots are changed to achieve different shading and outline effects, without having to use different shades of a color.

Printer device 106 can include a controller 107, which can include processor(s), non-volatile and volatile memory, and other components. The controller 107 can pre-process data from the computer device 102 so that it is ready for printing. The controller 107, for example, can receive PDS data from the computer device 102 (or other device) and can implement the processes of the present invention as described below with respect to FIGS. 5-11 to produce compressed data (and also perform the decompression for output). Alternatively, the controller 107 can receive data already compressed by the present invention (using another component, e.g., computer device 102 or other computer system) and decompress it to print the data. In still other embodiments, the compression and decompression of the present invention may occur in other devices, such as computer device 102, and the final decompressed page bitmap may be sent to controller 107 and printer device 106.

Display device 108 can be sent data from computer device 102 to display output from the data to a user. For example, display screens (cathode ray tube (CRT), liquid crystal display (LCD), etc.), projection devices, or other display devices can be used. In the context of the present invention, the display device 108 can be a raster display device that is able to display output from a page bitmap of data using scan lines and displayed pixels, as is well known in the art.

Facsimile device 110 can output text, images, or any other type of output similarly to the printer device 106 by a variety of well-known techniques. Furthermore, the facsimile device can receive data over a network or communication channel and provide the received data to computer device 102 if desired, where it can be stored by storage device 104, printed by printer device 106, displayed by display device 108, or otherwise manipulated.

The communication links between the various components of system 100 can be physical links (wire connections, network connections, etc.) or wireless links implemented via radio signals, infrared signals, etc. Computer system 102 and/or any of the peripheral devices can also include communication links to other computer systems or devices. The networked devices can communicate via one or more well-known networking or communication protocols.

FIG. 3 is a block diagram illustrating a rasterizing and compression system 150 of the present invention. This system can be implemented entirely within computer device 102 or in a peripheral device 106, 108, or 110, or some components of system 150 may be implemented in one device and other components in one or more other devices. The blocks of system 150 can represent software programs, hardware components, or a combination of these. The decompression system for decompressing data compressed by system 150 is described below with respect to FIG. 4.

PDS data 152 is provided to the system 150. PDS data 152 can be in a structured format (i.e., a page description language or PDL) that allows text and graphics in a document to be represented and output with high fidelity, or can be in an unstructured format, such as a scanned, raw bitmap obtained from a scanner device. Many structured formats provide data compact in storage requirements yet allow output pages generated from such a format to accurately depict the appearance of text, graphics, and images described by the format. Such formats can symbolically represent text characters, graphical objects and line-art, and other shapes using codes, and also include commands and description information to allow the output to appear in a desired and accurate way; for example, font, size, orientation, color, texture, and character position information can all be included in the PDS data. Furthermore, many such formats include images, and allow text, graphical objects, and images to be output next to or among each other. Structured formats suitable for use with the PDS data include PostScript from Adobe Systems, Inc., Intelligent Printer Datastream (IPDS) from IBM Corporation, Portable Document Format (PDF) from Adobe Systems, Inc., Printer Control Language (PCL) from Hewlett-Packard Development Company, Advanced Function Printing (AFP) from IBM Corp., and other formats.

The PDS data 152 is received by a rasterizer 154, which is able to analyze the PDS data and rasterize the PDS data into bitmap data. Rasterizer 154 can be implemented as software (or hardware) by a controller in an output peripheral device or computer device. Since each type of format of PDS data 152 which the system is designed to process is typically handled by a separate rasterizer, rasterizer block 154 represents a number of individual rasterizers, each individual rasterizer able to parse a different PDS format. In one application, the rasterizer 154 can generate a page bitmap for each page of data in the document that is described by the PDS data 152. In the present invention, the rasterizer can rasterize the PDS data into region bitmaps, character bitmaps, or portions of page bitmaps, as described below.

The rasterizer is able to parse descriptive information in the PDS data, if any, and is able to determine the appearance and other particulars of text, graphics, and images which appear in the bitmap which it is to create. This “descriptive information,” as the term is used herein, can include any of a variety of different types of information, and may depend on the particular format in which the PDS data is provided. For example, in some PDS formats, descriptive information can include region information, which describes how to segment the regions in the PDS document, i.e., the positions and dimensions of the regions, where each region has a type based on the classification of the data content in that region; thus, a text region includes text characters, a graphics region may include line-art objects or other drawn graphics, an image region may include an embedded bitmap, etc. In some structured formats, the included descriptive information includes a much greater amount of information, such as character symbolic codes or identifiers, the font information describing the fonts and appearance of text characters according to fonts in a font dictionary, etc. The rasterizer 154 can also provide or generate a form of descriptive information based on information in the PDS data, such as individual character bitmaps.

In the present invention, the rasterizer 154 retrieves particular information from the PDS data and provides that information as, and/or generates, descriptive information 156 such that an encoder 158 may access it. The particular descriptive information retrieved and provided may depend on the particular embodiment of the present invention that is implemented; this is discussed in greater detail below with respect to FIGS. 5 and 6. In an embodiment of the present invention, the descriptive information is provided to other components, such as the encoder 158, via a common interface such as a generalized application program interface (API) that is implemented in the environment in which the rasterizer 154 and encoder 158 are running and with which these components can communicate. For example, a single encoder 158 is able to communicate with every rasterizer type included in rasterizer 154, or any arbitrary rasterizer 154, by providing an API having parameters defining the type of rasterizer that is sending data to the encoder. The specific rasterizer can set its parameters within the API, and the encoder can read and interpret those parameters and thus know if any needed specific protocol is needed to communicate via the API.

In some embodiments, the rasterizer 154 also rasterizes a page bitmap (or part of a full page bitmap) 157 from PDS data 152, which is also made available to the encoder 158. The rasterizer uses any descriptive information and other information in the PDS data to create the (unstructured) page bitmap 157, including segmenting and determining the dimensions of regions, generating text character bitmaps based on font and size information, drawing graphical shapes as bitmaps, determining which regions are bitmap images and how to manipulate those images, etc. The page bitmap is independent of the specific PDL format that created it. In some embodiments, the page bitmap 157 is stored by the rasterizer in a page buffer implemented in memory of the device running the rasterizer (or other device in communication with the rasterizer), from which the encoder 158 reads the page bitmap. In other embodiments, the rasterizer 154 can treat the encoder 158 as a “virtual page buffer” and write the page bitmap directly to a buffer of the encoder 158, which can be logical or physically separate from buffers of the rasterizer 154. In some embodiments, there may be insufficient storage for the entire page bitmap, so that only a portion of it is written at once, and the rasterizer waits to write the next portion when the buffers are clear. For example, this can be used for banded data, and processing a fixed number of text lines at a time (smaller than the page height) if there is not enough memory to store an entire page. Some embodiments can divide the PDS data into pages of bitmap data (page bitmaps), while others may provide a continuous bitmap image not so divided.

Other embodiments may not create a page bitmap 157. For example, the rasterizer may be able to segment regions in the PDS data and provide each region directly and separately to the encoder 158 as one or more bitmaps, e.g., via the API, as additional descriptive information. In such an embodiment, the rasterizer 154 need never create a full page bitmap 157. In some embodiments, the rasterizer 154 may create a page bitmap 157 that does not include all its regions; e.g., text regions can be sent as descriptive information directly to the encoder 158, while the non-text regions can be rasterized into a page bitmap 157, from which the encoder 158 reads those non-text regions.

The encoder 158 is used to compress the bitmap data that was generated by the rasterizer 154 and provided to the encoder. Such bitmap data can include region bitmaps and/or character bitmaps sent as descriptive information (e.g. via the API), and/or page bitmap 157. The compressed data will eventually be placed into a page bitmap for output. Since the bitmap data is typically a large size in storage requirements, compression is desirable to facilitate the storage of the bitmap data in limited storage space, as well as speed the output process of the bitmap data. For example, it is typically much faster to decompress compressed bitmap data and output it with an output device, rather than rasterizing PDS data into a page bitmap at the time of output. Compressed bitmaps can therefore be provided from storage to a decoder and output device, as described with reference to FIG. 4, rather than providing the PDS data at the time of output.

According to the present invention, encoder 158 is a multi-region encoder, i.e., the encoder uses a suitable one of multiple available compression formats on data in a particular region based on the type of data it is. Thus, a multi-region encoder can compress a text region of a page using a text compression format, and compress an image region of the page using an image compression format. This allows superior compression to be achieved, since, for example, text compression formats are more efficient at compressing text than are other generalized formats or formats specific to other types of data. Image data compression formats can typically achieve higher compression ratios with images since lossy compression can be used; loss of data in compression of images is often acceptable since the overall appearance of the image is kept intact, but such lossiness may not be acceptable for other types of data.

The encoder 158 of the present invention is able to use highly efficient compression formats intended for specific types of data in different regions of the bitmap data provided by the rasterizer. This is because rasterizer 154 provides descriptive information 156 which includes information describing the regions and the types of data content in those regions. This allows the encoder 158 to use region-specific compression formats without having to analyze the page bitmap for region information, or without having to receive region information from some other program that has to analyze the page bitmap. With the use of region-specific compression schemes, a much superior compression can be achieved, especially compared to prior multi-region encoders, which typically used a generic compression scheme over the whole bitmap since region information was not readily available. Additional descriptive information may also be provided by the rasterizer in some embodiments to further speed the compression process, which are described in greater detail with respect to FIGS. 5 and 6.

In addition, since the encoder 158 receives the descriptive information 156 via the API used by the rasterizer, the encoder 158 and the rasterizer 154 can be designed independently and require only shared knowledge of the API, and need not define features in the same way. For example, the format of font dictionaries in the rasterizer does not need to be known or be compatible with any symbol dictionaries employed by the encoder 158. Similarly, the types of compression regions provided by the encoder are not necessarily tied to any particular region identification used in the rasterizer, since the API may be used to specify a broad category or generic type of compression to be used in each region, that broad category being translated into each component's own particular protocol. This independence of rasterizer and encoder allows arbitrary implementations of these components to be used, and also allows only one encoder 158 to be used with a wide variety of rasterizers, greatly reducing costs of the system.

Many types of compression can be used by encoder 158. A suitable compression “toolkit” for the present invention is JBIG2, which allows multi-region compression of bi-level images. JBIG2 provides symbolic representation in text regions, i.e., repeating shapes in a text region can be associated with a token in a symbolic dictionary, allowing a single character bitmap to be stored to represent a class of images, such as multiple occurrences of a character. JBIG2 also provides arithmetic and/or Huffman coders in some types of image regions.

In other embodiments, other types of compression toolkits or formats can be used, including CCITT Group-4 encoding, Joint Photographic Experts Group (JPEG) for lossy compression, etc. Multiple, region-tailored compression formats can be used to efficiently compress multiple types of data.

In some embodiments, the encoder 158 may receive individual region (or other individual, divided or sectioned) bitmaps that include the data from the PDS data 152 that would otherwise go into the page bitmap, and which can be compressed by the encoder 158. In some of these embodiments, a page bitmap 157 is not produced by the rasterizer 154, while in others, a page bitmap 157 is provided by the rasterizer which includes regions or sections of a page that were not sent as individual bitmaps or descriptive information.

The encoder 158 produces compressed data 160, which can be stored on a storage device 104, sent to an output device, copied across a network to a server or computer device, or otherwise manipulated as desired. If the compressed data 160 is to be output by an output device such as printer device 106, display device 108, or facsimile device 110, then the components described in FIG. 4 can be used. The compressed data 160 is typically much smaller in storage requirements than the page bitmap 157 due to the compression provided by encoder 158.

Alternatively, the input PDS data 152 may be unstructured, e.g. a raw bitmap without having any structure as provided by a page description language (PDL). For example, a bitmap can be generated by a scanner device, a different rasterizer, or other component or device. The rasterizer 154 cannot retrieve descriptive information about this bitmap, and thus creates a page bitmap that is approximately the same as the input bitmap, and provides any resizing, padding, rotating, or other processing appropriate for output of a particular output device. Since the page bitmap has not been created by rasterizer 154 from structured PDS data, the encoder 158 does not receive any descriptive information to assist compression; however, the encoder 158 may be able to do some bitmap analysis of its own to determine efficient compression schemes, as described below with reference to FIG. 5.

In some embodiments, an additional transcoder 162 can be positioned between the rasterizer 154 and the encoder 158. The transcoder can convert a compressed image in the PDS data to a compression scheme more suitable for the encoder 158, and can use descriptive information from the rasterizer in this task. This is described in greater detail below with respect to FIGS. 6 and 10.

FIG. 4 is a block diagram illustrating a decompression and output system 170 of the present invention. System 170 receives the compressed data 160 that was provided by the encoder 158 as described above with reference to FIG. 3. The compressed data 160 can be retrieved from a storage device 104, networked computer device, or other device. Or, the compressed data 160 can be immediately provided to system 170 for output after the encoder 158 has produced it.

The compressed data 160 is provided to a decoder 172, which is able to decompress the compressed data with the appropriate decompression formats that are analogous to the compression formats used by the encoder 158. Thus, the decoder 172 is able to determine the various regions in the compressed data and use the appropriate decompression format for each region to decompress the data into its decompressed form.

The decoder 172 provides the decompressed data to a page makeup block 174. Block 174 can be implemented within the decoder 172, e.g., as part of the decompression process. Alternatively, the page makeup block 174 can be a separate functional block, or located within another component, such as rasterizer 154. Page makeup block 174 builds one or more page bitmaps 176 from the decompressed data provided by decoder 172. The page bitmap 176 is approximately the same (in page form) as the bitmap data produced by rasterizer 154 in FIG. 3, except for any loss of data that may have resulted from compression and decompression.

The page bitmaps 176 are provided to an output hardware component 178, which provides the output image 180 as appropriate to the type of output device used. For example, the output component 178 can be a printing mechanism in a printer device, or a display apparatus and screen in a display device. The output image 180 represents the desired output resulting from PDS data 152 of FIG. 3.

Some embodiments may use “display list” processing, which builds a page from a list of elements that are placed in the page bitmap immediately before printing, and there is not enough memory to store all the elements in the page bitmap. Thus, an intermediate form, the compressed data, is provided to fit in memory, and the page is later composed for output. The page can be composed by specialized hardware as it is printing, or by software creating each scanline as needed to send to the output mechanism. This can be accomplished by knowing the positions of the various regions and decoding parts of them as needed for output.

FIG. 5 is a flow diagram illustrating a method 200 of the present invention for rasterizing and encoding (compressing) multi-region data. Method 200, as well as the other methods described herein, are preferably implemented using program instructions (software, firmware, etc.) that can be executed by a computer system, such as computer device 102 and/or an output peripheral device such as printer device 106 or display device 108, and are stored on a computer readable medium, such as memory, hard drive, optical disk (CD-ROM, DVD-ROM, etc.), magnetic disk, etc. Alternatively, these methods can be implemented in hardware (logic gates, etc.) or a combination of hardware and software.

The method begins at 202, and in step 204, PDS data 152 is received at the rasterizer 154. The rasterizer can receive the PDS data over a bus, network connection, or other communication channel. If multiple types of rasterizers are provided (e.g., one for Postscript format, one for IBM IPDS, etc.), the particular type of rasterizer which can interpret the type of PDS data is provided that data. In step 206, the method checks whether descriptive information is available in the PDS data. If the PDS data is an unstructured bitmap having no region or segmentation information, character or symbol identification, or other descriptive information of use in the present invention, then there is no descriptive information available, and the method continues to step 220, detailed below.

If descriptive information is available, the process continues to step 208, in which the rasterizer retrieves the descriptive information from the PDS data in anticipation of building bitmap data. In step 210, the rasterizer provides appropriate descriptive information to the encoder 158. The descriptive information is, in the described embodiment, provided via an API that is also known to the encoder, since such an implementation allows the rasterizer to be designed independently from the encoder, as explained above with reference to FIG. 3. In other embodiments, the rasterizer can provide descriptive information directly to the encoder 158 without an API. The content of the descriptive information provided by the rasterizer can vary depending on the embodiment—minimal descriptive information can be provided, requiring a minimal degree of cooperation between rasterizer and encoder, or a greater amount of information can be provided, requiring greater cooperation. Some embodiments and examples including different levels of descriptive information are described in greater detail with respect to FIG. 6.

In optional step 212, rasterizer 154 creates a page bitmap from the PDS data according to well-known techniques. It should be noted that steps 210 and 212 can be performed in any order, or simultaneously. As noted above, in some embodiments, a page bitmap need not be created, since individual or separate bitmap data components, collectively depicting the PDS data, can be provided directly to the encoder from the rasterizer in step 210. Or, the page bitmap created in step 212 may not include all the regions of the PDS data, since the bitmap data in those other regions were provided to the encoder in the descriptive information (in step 210).

In step 214, the encoder compresses the bitmap data, provided by the rasterizer and depicting the PDS data, using the descriptive information provided by the rasterizer. As explained above, the encoder is a multi-region encoder that can compress different region types according to compression formats more suitable for those region types, achieving greater compression ratios and speed. The descriptive information assists this multi-region encoding.

For example, descriptive information such as region information from the rasterizer designates the regions in the bitmap data, e.g., indicates the regions' positions and dimensions and types of content in the regions, and can be used by the encoder to select and use the appropriate compression algorithms appropriate for those types. Other descriptive information such as character bitmaps and character identification information can be used to greatly reduce the speed of compressing text regions. Several embodiments of encoding using descriptive information are as described in greater detail with respect to FIGS. 7-10.

Once the encoder has compressed the bitmap data in step 214, the compressed data can be stored, transmitted for processing in another device, and/or output, as described above with respect to FIG. 3. The process is then complete at 216.

Step 220 is performed if no descriptive information was found to be available in the PDS data in step 206. In step 220, the rasterizer creates a page bitmap from the PDS data, similar to step 212. The rasterizer may need to perform some processing to the PDS data to create the page bitmap, such as resizing, padding, clipping, and rotating. In step 222, the encoder reads the page bitmap and attempts to infer region characteristics therein, e.g., by analyzing bit patterns or features in the page bitmap. For example, the encoder can try to infer region content types in the bitmap by analyzing black/white transition frequency (where a high transition rate may indicate text lines, etc.), or normalized run-end counts.

In step 224, the process checks whether region type(s) can be inferred from the analysis of step 222, and, if so, whether all regions so inferred are likely to have text content. If both conditions apply, then the process continues to step 214 where the encoder compresses the page bitmap using the inferred descriptive information. For example, the inferred descriptive information may include region information that defines the dimensions and positions of the text regions and the non-text regions.

If any region types cannot be inferred from such analysis, or if any regions are determined as unlikely to be text, then the process continues to step 226, in which a generic region encoding can be used. For example, JBIG2 has a generic compression scheme available which is used in such cases, which provides an overall acceptable compression ratio and speed. Such generic compression schemes are typically more efficient for unknown content than encoding for specific content types, e.g. text-region encoding can be inefficient on halftone images or line-art (graphics) regions. The process is then complete at 216.

FIG. 6 is a flow diagram illustrating step 210 of FIG. 5, in which the rasterizer provides descriptive information to the encoder. Each successive step of method 210 illustrates a greater amount of descriptive information being provided by the rasterizer in a different embodiment. Where possible, the steps need not be performed in the order shown in method 210.

The process begins at 252, and in step 254, the rasterizer provides region information to the encoder as descriptive information. This is the most basic embodiment of the invention, and requires the least amount of cooperation between rasterizer and encoder. In generated, structured documents or data, the rasterizer can access the region segmentation data, including positions and dimensions of different regions in the data, i.e., how the different regions are segmented. Furthermore, the rasterizer is also able to access the types of the data included in the segmented regions, such as graphical line-art or object, or images (some of the types of regions may be identified or labeled, and well-defined, in the PDS data). In some scanned documents and bitmaps, region information may also be available to the rasterizer; for example, front-end region segmentation may have been performed for the scanned document between contone (continuous tone, multiple shades for each pixel) and bitonal (two pixel levels) scanned regions. The rasterizer can access the positions and dimensions of such regions.

The accessed region information may also include other region characteristics. For example, in halftone image regions, the rasterizer may also have access to region information such as the halftone screen that is used for the screening of the halftone image data (i.e., the halftone screen characteristics, such as dot size and shape, screen angle and ruling, etc.).

In standard controllers or control units used on many printer devices and other output devices, such as Advanced Function Common Control Unit (AFCCU) by IBM Corporation, the rasterizer can access all of these types of region information.

The rasterizer is able to provide any or all of this region information to the encoder 158 to assist the encoder in selecting different compression formats for different regions. Encoder embodiments which receive the region information of step 254 are described below with respect to FIGS. 7-9, more specifically with respect to FIG. 7.

One embodiment of the invention provides descriptive information only including the region information of step 254; this embodiment is described below with respect to FIG. 7.

Other embodiments can provide additional descriptive information, as indicated in step 256. This especially applies to text regions having text data. In step 256, the rasterizer 154 additionally provides character bitmaps as descriptive information to the encoder 158. When the PDS data includes structured (generated) text regions, the rasterizer for that type of structured format typically has access to a font dictionary which includes the character bitmaps in the particular fonts used in the PDS data, so that the rasterizer can create a page bitmap having the desired appearance of the text characters. The rasterizer, in parsing the PDS data, determines the position in the page bitmap to place each character bitmap.

In the present invention, the rasterizer can provide these character bitmaps, as well as the text placement information indicating the positions where they will be placed in the page bitmap, to the encoder. This allows the encoder to receive already-extracted shapes in the page bitmap without having to extract those shapes itself. Each text region is already effectively tokenized, i.e. all the shapes have been already effectively extracted in the text regions, and thus the encoder need only perform pattern matching, as described below with reference to FIG. 8.

In some embodiments, a similar step can be performed for line-art graphics regions, which include graphical shape bitmaps that the rasterizer can draw based on commands in the PDS data. The rasterizer can create these graphical shape bitmaps and provide them to the encoder 158 with their positions as descriptive information, and the encoder can process the graphics bitmaps similar to the character bitmaps as described above.

Since the character bitmaps and their relative positions (e.g., coordinates) in the page layout are provided to the encoder directly in step 256 as descriptive information, the rasterizer need not actually build or create the text regions of the page bitmap that include those character bitmaps. (Similarly, if graphical objects are treated similarly, graphical regions of the page bitmap need not be created by the rasterizer.)

An encoder embodiment which receives the region information of step 254 and the character bitmaps of step 256, and compresses text regions in the page bitmaps provided by the rasterizer, is described below with respect to FIG. 8.

Other embodiments can provide additional descriptive information to the encoder 158, as indicated by step 258. In step 258, the rasterizer 154 provides character identification information, in addition to character bitmaps, as descriptive information to the encoder 158 for text regions of the PDS data. The higher-level character identification information saves additional processing time in the encoder. When the PDS data includes structured text regions, the rasterizer typically has access to the character identification information which can include, for each text character, a character number or character code (e.g., an ASCII code), as well as a font number or code that identifies the font to be used with the character. This information allows the rasterizer to provide the proper character bitmap for a character, in the proper font, from its font dictionary. In some embodiments, point size information can also be provided as character identification information to indicate the proper display size of text, or other types of character identification information can be provided.

In the present invention, the rasterizer can provide all or some of the character identification information to the encoder so that the encoder need not perform the pattern matching of character bitmaps as needed in the above embodiments. As in the embodiment of step 256, the page bitmap built by the rasterizer (if one is built) need not include the text regions that include the character bitmaps and character identification information sent to the encoder. An encoder embodiment which receives the region information of step 254, the character bitmaps of step 256, and the character identification information of step 258, and compresses text regions in the page bitmaps provided by the rasterizer, is described in greater detail with respect to FIG. 9. Text information provided as descriptive information from the rasterizer to the encoder, including character bitmaps, text placement information, and character identification information, can also be referred to a “symbolic text data,” which is encoded by the encoder into compressed text data.

Other embodiments can provide additional descriptive information to the encoder 158, such as indicated in step 260. In step 260, the rasterizer 154 additionally provides image compression format information as descriptive information to the encoder 158. Structured PDS data 152 may include embedded image data that was previously compressed in a particular format. This image data may be embedded in a page of document with other kinds of data, such as text characters, graphics objects or line-art, etc. The rasterizer is able to access information in the PDS data indicating the particular compression format used for the embedded image data, and could, if necessary, decompress the image so that the image could be included in the page bitmap.

However, in the present invention, such decompression can be avoided by providing the embedded compressed image, still in its compressed form, to the API. The rasterizer also provides the descriptive information describing the compression format of the embedded image to the API. Both the compressed image and the descriptive information can be received by a transcoder 162, which can also communicate with the API. The transcoder can be used to convert the compressed image to a compressed format usable by the encoder. This is described in greater detail with respect to FIG. 10. When the transcoder is a speed and compression-efficient type, this feature can greatly increase the speed at which compressed images are provided in the compressed data 160 produced by the encoder.

If the rasterizer rasterizes different regions separately, each bitmapped region can be provided individually via the API to the encoder in addition to the descriptive information, similar to the embedded image data described above, rather than building a page bitmap in standard fashion.

The process is complete at 262.

FIG. 7 is a flow diagram illustrating a process 300 of data compression used by the encoder of the present invention in which the encoder 158 has received region information from the rasterizer, as from step 254 of FIG. 6. This process is greatly simplified over actual implementations, such as provided in JBIG2, and is meant to show the general steps in the process.

The process begins at 302, and in step 304, the encoder determines the regions and their types in the page bitmap 157 (or other received bitmap regions or data) based on the region information provided by the rasterizer preferably via the API. Using the region information, the encoder is able to determine the positions and dimensions of the regions, as well as the types of data in the regions. Any non-text regions in the bitmap data are compressed in step 306 with appropriate compression formats, where step 306 can be performed at any appropriate time, e.g. before, after, or concurrently with the text compression described in steps 308-318. For example, JBIG2 provides text, generic, and periodic/halftone region compression algorithms, and the region information provided by the rasterizer allows the JBIG2 encoder to identify the regions in the bitmap data and select between these algorithms for the appropriate algorithm for each identified region in the page bitmap.

In addition, region information may include halftone information, such as the period of dots or screen description information, which can be received by the encoder from the rasterizer to describe a periodic/halftone region, and which facilitates the encoder's compression of the periodic/halftone data, e.g., facilitating descreening, if descreening is desired, or facilitating periodicity selection for JBIG2 periodic region compression. Descreening is spatial filtering or averaging that is used to convert halftoned image data into continuous-tone image data, and may be performed, for example, prior to JPEG compression of an image that had been previously halftoned, or “screened.” JBIG2, for example, can normally determine and extract a halftone period from image bitmap data; however, if the rasterizer provides the halftone data as in appropriate embodiments of the present invention, then the encoder does not need to do so, thereby saving time and processing cycles. In addition, having the rasterizer access accurate halftone screen information from the PDS data and provide that to the encoder can mitigate the risk of improper determination of screen frequencies if the encoder were to determine this information itself. Such improper determination can degrade decompressed image quality.

In some embodiments, when the encoder implements a compression toolkit such as JBIG2, several templates are available for use in generic region encoding, where a “template” is a set of image pixels used to predict the value of a coded pixel. A generic region is a region having any type of bitmapped features that have not been identified as a particular type, which has multiple types, or which has no specific compression format. Particular templates may be more suitable for some types of data rather than other types, e.g. graphical line-art or objects rather than images. Region information received by the encoder from the rasterizer describing the specific data content of a generic region can be used to select between templates. For example, a Graphics Object Content Architecture (GOCA) piechart can be a graphical object having a relatively simple structure, and may be a good match for a smaller, simpler template to allow faster encoding. However, a complex halftoned image may be better suited to a more complex template, which can provide a better compression ratio for that type of content.

Steps 308-318 describe symbolic text compression for the embodiment of FIG. 7. In step 308, the encoder analyzes a segmented text region of the page bitmap for shapes, which, in text regions, would typically correspond to character bitmaps, and extracts a shape. Techniques are well-known for analysis of connected pixels and the drawing of bounding boxes around shapes, which are then extracted. The encoder need only analyze designated text regions for text characters, since the encoder has been informed by the region information that other regions have other types of data content.

In step 310, after one of these shapes has been extracted, the process checks whether the extracted shape matches a token (previously-stored representative bitmap shape) in the dictionary being built by the encoder for this PDS data or page. To perform this match, the process can compare the bit pattern of the shape to the token (approximate matches are possible, within a predetermined tolerance, e.g., for scanned data, where there may be small differences in two bitmaps representing the same character). If no match is found to any of the tokens in the dictionary, then in step 312 the shape is stored in the dictionary as another token, representative of that shape, which will be compared to other shapes found in future iterations. After step 312, or if the extracted shape was found to match a token, then specific information is stored for the extracted shape in step 314, where the specific information can include a unique identifier for the shape, the position of the shape in the region or page, and a link to the associated token. The process then checks in step 316 whether any other shapes need to be extracted from the text region; if so, the process returns to step 308. If not, the process can perform additional compression at step 318 to compress the tokens and specific information for the shapes, and the process is complete at 319. If additional text regions in the page bitmap are to be compressed, the process can begin again at 302.

FIG. 8 is a flow diagram illustrating a process 320 of data compression used by the encoder of the present invention, in which the encoder has received region information and character bitmaps from the rasterizer, as from step 256 of FIG. 6.

The process begins at 322, and in step 324, the encoder determines the regions and their types in the page bitmap 157 and/or other bitmap data based on the region information provided by the rasterizer, similarly as described with reference to step 304 of FIG. 7 (only a minimum amount of region information for a text region, describing the position and/or extent of the text region, may be needed). In step 326, any non-text regions in the bitmap data are compressed with appropriate compression formats, where step 326 can be performed at any appropriate time, e.g. before, after, or concurrently with steps 328-338.

In step 328, the encoder gets a character bitmap. This character bitmap would have been provided to the encoder by the rasterizer as (generated) descriptive information, as indicated in step 256 of FIG. 6, e.g., through an API. In addition, the encoder receives text placement information (position information) associated with each character bitmap, which indicates where in a page bitmap (or other size of bitmap) the associated character information is positioned or displayed. In step 330, the process checks whether the character bitmap matches a token (previously-stored representative character bitmap) in the dictionary being built by the encoder for this PDS data or page. To perform the match, the process can compare the bit pattern of the current character bitmap to the character bitmap stored in the symbol dictionary (as explained previously, the matches can be approximate). If no pattern match is found to any of the tokens in the dictionary, then in step 332 the character bitmap is stored in the dictionary as another token, representative of that character bitmap, which will be compared to other character bitmaps found in future iterations. After step 332, or if the current character bitmap was found to match a token (in which case the current character bitmap need not be stored), then specific information is stored for the occurrence of the character bitmap in step 334, where the specific information can include a unique identifier for the character bitmap, the placement information for the character bitmap in the region or page, and a link to the associated token. The process then checks in step 336 whether any other character bitmaps in the text region have been received and need to be processed, e.g., pattern matched and stored; if so, the process returns to step 328. If not, the process can perform additional compression at step 338 to compress the tokens and specific information for the character bitmaps, and the process is complete at 340. If character bitmaps from additional text regions in the page are received, the process can begin again at 322.

Thus, due to receiving the character bitmaps, this method avoids the analysis of the page bitmap or other bitmap data, the drawing of bounding-boxes around shapes in the bitmap data, and the extraction of shapes that are found in the encoder embodiment of FIG. 7, thereby saving significant processing time at the encoder.

It should be noted that the encoder can first store all the character bitmaps received from the rasterizer in the encoder's own buffer and then perform the pattern matching and compression on all the received character bitmaps; or, compression can be performed as each character bitmap is received at the encoder (i.e., a character bitmap is never stored in the encoder's buffer if it already exists in the dictionary).

FIG. 9 is a flow diagram illustrating a process 350 of data compression used by the encoder of the present invention, in which the encoder has received region information, character bitmaps, and character identification information from the rasterizer, as from step 258 of FIG. 6.

The process begins at 352, and in step 354, the encoder determines the regions and their types in the page bitmap 157 or other bitmap data based on the region information provided by the rasterizer, similarly as described with reference to step 304 of FIG. 7. In step 356, any non-text regions in the bitmap data are compressed with appropriate compression formats, where step 356 can be performed at any appropriate time, e.g., before, after, or concurrently with steps 358-368.

In step 358, the encoder gets a character bitmap (and its placement information describing its position in the region or page) and character identification information, where the character identification information includes character codes, font codes, point size information, and/or other character identifying or character description information. The character identification information would have been provided to the encoder by the rasterizer, as indicated in step 258 of FIG. 6, e.g., through an API.

In step 360, the process checks whether the character identification information matches (or approximately matches) any already-stored character identification information (token) in the dictionary being built by the encoder for this PDS data or page. The process compares some or all of the current character identification information (e.g., the character code and font code for a character) with the equivalent stored codes of the tokens to determine whether the associated character bitmap is already in the dictionary (the dictionary includes character identification information and character bitmaps of tokens). Thus, this embodiment can save significant processing time over the embodiments of FIGS. 7 and 8, in which the encoder had to match the bit patterns of shapes or characters to the bitmaps of tokens, and this embodiment can construct a symbol dictionary for the page very quickly.

If no match is found to any of the character identification information in the dictionary, then in step 362 the character bitmap associated with the character identification information is stored in the dictionary, so that the correct-appearing bitmap can later be generated; and the associated character identification information is stored in the dictionary as a token, representative of that character, which will be compared to other characters received in future iterations. After step 362, or if the current character identification information matches a token (in which case the current character bitmap and character identification information need not be stored in the dictionary), then in step 364 specific information is stored for the occurrence of the character bitmap, where the specific information can include a unique identifier for the character, the position of the character in the region or page, and a link or reference to the associated character bitmap. The process then checks in step 366 whether any other character identification information for characters in the text region have been received and need to be processed, e.g., compared and stored; if so, the process returns to step 358. If not, the process can perform additional compression at step 368 to compress the character bitmaps and specific information for the characters, and the process is complete at 370. If characters from other text regions in the page are received from the rasterizer, the process can begin again at 352.

As in the embodiment of FIG. 8, the encoder can first store all the character identification information received from the rasterizer in the encoder's own buffer and then perform the processing and compression on all the received characters, or, compression can be performed as each character identification information is received at the encoder.

In some alternate embodiments, the rasterizer 154 can check whether character identification information and character bitmaps have already previously been sent to the encoder 158, and can send character bitmaps to the encoder only when those bitmaps have not previously been sent. Or, the rasterizer can send some other accompanying information indicating that the sent character data is the same as previously sent character data. Thus, in some of these embodiments, the check of step 360 may not be needed, since the encoder could determine whether received character identification information were a token or not by checking for a lack of accompanying character bitmap, or by checking other received information.

FIG. 10 is a flow diagram illustrating a process 400 of the present invention to compress an embedded compressed image, where compressed image information has been received from the rasterizer, as from step 260 of FIG. 6. In this process, a transcoder 162 (see FIG. 3) is provided between the rasterizer 154 and the encoder 158 and implements the process. The transcoder is able to convert an image in one compressed format directly into an image of another compressed format.

The process begins at 402, and in step 404, the transcoder receives embedded image format information (descriptive information) from the rasterizer, as indicated in step 260 of FIG. 6, e.g., through an API. This information describes the compression format of the embedded compressed image data, so that the transcoder knows which compression format to use. The format information may also include other descriptive information for the transcoder to perform image processing operations, if needed, such as information describing needed clipping, padding, scaling, and rotating. In step 406, the transcoder receives the embedded compressed image directly from the rasterizer (and not via a rasterized page bitmap), e.g., via the API (steps 404 and 406 can be performed in any order). In step 408, the transcoder converts the embedded compressed image into an embedded compressed image having a compression format compatible with the encoder 158; this can be performed because the transcoder knows the original compression format of the image and knows an equivalent compression format that is used by the encoder. In step 410, the transcoder provides the converted embedded compressed image (in the encoder-compatible compression format) to the encoder, which incorporates the embedded image in the compressed data 160 produced by the encoder.

For example, in a JBIG2-encoder embodiment, the transcoder 162 can convert an image in an original arithmetic compression format into the equivalent, JBIG2 arithmetic compression format, and the encoder can then receive this compressed image directly and include it in its own compressed data output without any further processing. When the transcoder is fast and efficient, this feature can greatly increase the speed at which compressed images are provided in the compressed data 160 produced by the encoder, since no decompression need be performed by the rasterizer.

This embodiment may require that no scaling, padding, clipping, or rotation of the embedded compressed image is required when the embedded image is inserted into a page bitmap just before it is output, i.e., the embedded image may be placed directly into the output page bitmap at the decompression stage of the decoder 172 without needing any such scaling, padding, or rotation. Padding is the insertion of content around an image (e.g., white space) so that a smaller image can be placed in a larger area, or so that some of the adjacent content to an image can be blanked next to the image (generally, this assumes that the image has already been screened). This work would normally be performed by the rasterizer, but in the present invention this can be avoided. Alternatively, if the embedded image needs to be scaled, padded, clipped, and/or rotated, the transcoder 162 can be used to perform such operations while it is converting the input compression format into the encoder's compression format. These operations may in some embodiments involve some degree of decompression and re-compression of the image data by the transcoder, depending on the transcoder process used. The embodiment of FIG. 10 can be used with the encoder embodiments of FIGS. 7, 8, and 9, or used by itself.

FIG. 11 is a flow diagram illustrating the decoding (decompression) process 450 of the present invention. This process typically follows the compression process 200 of FIG. 5 and is used to decompress the compressed data 160, build an output page bitmap therefrom, and output the data using an output device, as described above with respect to FIG. 4.

The process begins at 452, and in step 454, the decoder 172 receives the compressed data 160 that has been compressed by the encoder 158. In step 456, the decoder decompresses the compressed data using the analogous compression format(s) that the encoder used. The decoder can determine the compression formats used in particular compressed data by reading associated information in the compressed data, and use that information to select one of the several compression formats available to the multi-region encoder/decoder.

In step 458, a page bitmap 176 is built from the decompressed data. In some embodiments, this step can be combined with the decompression step 456. For example, in a text region that is compressed as indicated above, character symbol information is read, indicating a particular character and its font, and the corresponding character bitmap is retrieved from the dictionary that is included in the compressed data; the character bitmap is then inserted in the page bitmap 176 at the position included in the character symbol information. Or, the read character symbol information can be a reference to a character bitmap in a dictionary, so that the decoder does not need to reference a font. An image region is similarly decompressed according to a particular compression format and is inserted into the page bitmap. If the decoder implements the page building functions, the decoder can place each decompressed region into the page bitmap as the region is decompressed; or, in other embodiments, all the regions can be decompressed into a buffer and then regions are inserted into a page bitmap. Alternatively, the page building finctions can be implemented by other components.

In step 460, the page bitmap 176 is output as an output image by the output component 178 of a raster output device, such as a display screen, printer, etc. The process is then complete at 462. Additional page bitmaps can be similarly decompressed and output.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for rasterizing and encoding data, the method comprising:
deriving descriptive information from print data stream (PDS) data, the PDS data describing output for an output device, wherein the descriptive information includes
a designation of at least one region of text data in the PDS data, and
bitmap data depicting the at least one region of text data;
providing the bitmap data to an encoder without including the bitmap data in a rasterized page bitmap of the PDS data; and
encoding the bitmap data into compressed data using the encoder and a compression format suitable for text data, the compressed data depicting the at least one region of text data.

2. The method of claim 1 wherein the bitmap data includes a plurality of individual character bitmaps, each representing a character in the at least one region of text data, and wherein the descriptive information is used in the encoding and includes placement information describing the positions of the individual character bitmaps within an output page.

3. The method of claim 1 wherein the designation of the at least one region of text data includes segmentation information describing the position and dimensions of the at least one region of text data in an output page of the PDS data.

4. The method of claim 1 further comprising:
deriving non-text descriptive information from the PDS data, the non-text descriptive information including a designation of at least one non-text region of data in the PDS data;
rasterizing the at least one non-text region of data into non-text bitmap data; and
encoding the non-text bitmap data into non-text compressed data, wherein the designation of the at least one non-text region is used in the encoding to determine a compression format suitable for the at least one non-text region of data.

5. The method of claim 4, wherein the at least one non-text region of data is rasterized into a page bitmap.

6. The method of claim 4 wherein the type of data in the at least one non-text region is determined from the non-text descriptive information, and wherein the type is used to select one of a plurality of available compression formats for the encoding, wherein each available compression format is suitable for a particular type of data.

7. The method of claim 6 wherein the type the at least one non-text region is an image type.

8. The method of claim 2 wherein the descriptive information includes character identification information retrieved from the PDS data, wherein the individual character bitmaps are derived from the character identification information.

9. The method of claim 8 wherein the encoding includes:
constructing a symbol dictionary by comparing each character bitmap with character bitmaps already stored in the symbol dictionary to determine if the received character bitmap is already stored in the dictionary, and
storing a character bitmap in the symbol dictionary if that character bitmap is not already stored therein.

10. The method of claim 8 further comprising providing the character identification information to the encoder and using the character identification information in the encoding, wherein the character identification information includes character codes identifying characters in the PDS data, each character associated with one of the character bitmaps.

11. The method of claim 10 wherein the character identification information includes at least one of font codes identifying the font of each of the characters, and point size information identifying the size of each of the characters.

12. The method of claim 10 wherein the encoding includes:
constructing a symbol dictionary by comparing each particular character code with character codes already stored in the symbol dictionary to determine if the character bitmap associated with the particular character code is already stored in the dictionary, and
storing a character bitmap and associated particular character code in the symbol dictionary if the associated particular character code is not already stored therein.

13. The method of claim 6 wherein the type of data in the at least one non-text region is image data that has previously been compressed, and wherein the non-text descriptive information includes information describing the previous compression.

14. The method of claim 13 further comprising converting the previously compressed image into a compressed image having one of the available compression formats for the encoding.

15. The method of claim 4 wherein if no text descriptive information or non-text descriptive information exists in the PDS data, further comprising analyzing the rasterized page bitmap for information indicating a segmentation of at least one region in the rasterized page bitmap.

16. The method of claim 1 wherein the bitmap data is provided for use in the encoding via a generalized application program interface (API).

17. The method of claim 1 wherein the compressed data is decompressed.and a page bitmap is built from the decompressed data, wherein the page bitmap is output from an output device.

18. A system for rasterizing and encoding data, the system comprising:
a rasterizer that receives print data stream (PDS) data, the PDS data describing output for an output device, wherein the rasterizer derives descriptive information from the (PDS) data, the descriptive information including
a designation of at least one region of text data in the PDS data, and
bitmap data depicting the at least one region of text data; and
an encoder coupled to the rasterizer, the encoder receiving the bitmap data directly from the rasterizer without retrieving the bitmap data from a rasterized page bitmap, the encoder encoding the bitmap data into compressed data that depicts the at least one region of text data using a compression format suitable for text data.

19. The method of claim 18 wherein the bitmap data includes a plurality of individual character bitmaps, each representing a character in the at least one region of text data, and wherein the descriptive information is received by the encoder and includes text placement information describing the positions of the individual character bitmaps within an output page.

20. The method of claim 18 wherein the rasterizer derives non-text descriptive information from the PDS data, the non-text descriptive information including a designation of at least one non-text region of data in the PDS data, and rasterizes the at least one non-text region of data into non-text bitmap data, and wherein the encoder encodes the non-text bitmap data into non-text compressed data, wherein the designation of the at least one non-text region is used in the encoding to determine a compression format suitable for the at least one non-text region of data.

21. The system of claim 20 wherein the descriptive information indicates the type of data in the at least one region, and wherein the encoder receives and uses the type to select one of a plurality of available compression formats for the encoding, wherein each available compression format is suitable for a particular type of data.

22. The system of claim 19 wherein the encoder constructs a symbol dictionary by comparing each character bitmap with character bitmaps already stored in the symbol dictionary to determine if the received character bitmap is already stored in the dictionary, and stores a character bitmap in the symbol dictionary if that character bitmap is not already stored therein.

23. The system of claim 19 wherein the descriptive information includes character identification information retrieved from the PDS data, and wherein the individual character bitmaps are derived from the character identification information, and further comprising using the character identification information in the encoding, wherein the character identification information includes character codes identifying characters in the PDS data, each character associated with one of the character bitmaps.

24. The system of claim 23 wherein the encoder constructs a symbol dictionary by comparing each particular character code with character codes already stored in the symbol dictionary to determine if the character bitmap associated with the particular character code is already stored in the dictionary, and stores a character bitmap and associated particular character code in the symbol dictionary if the associated particular character code is not already stored therein.

25. The system of claim 20 wherein the type of data in the at least one non-text region is a compressed image that has previously been compressed using a compression format, and wherein the descriptive information includes information describing the previous compression format.

26. The system of claim 25 further comprising a transcoder that receives the descriptive information from the rasterizer and converts the compressed image into an equivalent compressed image having one of the available compression formats for the encoding, wherein the transcoder provides the equivalent compressed image to the encoder.

27. The system of claim 18 wherein the rasterizer provides the descriptive information to the encoder via an application program interface (API).

28. The system of claim 18 wherein a decoder receives the compressed data and decompresses the data and builds an output page bitmap, and an output device outputs the output page bitmap.

29. A computer readable medium including program instructions to be implemented by a computer, the program instructions for rasterizing and encoding data, the program instructions implementing steps comprising:
deriving descriptive information from print data stream (PDS) data, the PDS data describing output for an output device, wherein the descriptive information includes
a designation of at least one region of text data in the PDS data, and
bitmap data depicting the at least one region of text data;
providing the bitmap data to an encoder without including the bitmap data in a rasterized page bitmap of the PDS data; and
encoding the bitmap data into compressed data using the encoder and a compression format suitable for text data, the compressed data depicting the at least one region of text data.

30. The computer readable medium of claim 29 wherein the bitmap data includes a plurality of individual character bitmaps, each representing a character in the at least one region of text data, and wherein the descriptive information is used in the encoding and includes text placement information describing the positions of the individual character bitmaps within an output page.

31. The computer readable medium of claim 29 further comprising:
deriving non-text descriptive information from the PDS data, the non-text descriptive information including a designation of at least one non-text region of data in the PDS data;
rasterizing the at least one non-text region of data into non-text bitmap data; and
encoding the non-text bitmap data into non-text compressed data, wherein the designation of the at least one non-text region is used in the encoding to determine a compression format suitable for the at least one non-text region of data.

32. The computer readable medium of claim 31 wherein the type of data in the at least one non-text region is determined from the non-text descriptive information, and wherein the type is used to select one of a plurality of available compression formats for the encoding, wherein each available compression format is suitable for a particular type of data.

33. The computer readable medium of claim 30 wherein the descriptive information includes character identification information retrieved from the PDS data, and wherein the individual character bitmaps are derived from the character identification information, and further comprising providing character identification information to the encoder and using the character identification information in the encoding, wherein the character identification information includes character codes identifying characters in the PDS data, each character associated with one of the character bitmaps.

34. The computer readable medium of claim 29 wherein the bitmap data is provided for use in the encoding via an application program interface (API).

35. A method for rasterizing and encoding data, the method comprising:
deriving descriptive information from print data stream (PDS) data using a rasterizer, the PDS data describing output for an output device, wherein the descriptive information includes a description of at least one region of data in the PDS data; and
producing bitmap data derived from the PDS data and including the at least one region of data, the bitmap data produced using the rasterizer;
providing the descriptive information from the rasterizer to an encoder via a general application program interface (API) allowing communication between the rasterizer and the encoder; and
encoding the bitmap data into compressed data using the encoder, the bitmap data derived from the PDS data, wherein the descriptive information is used in the encoding to determine a compression format suitable for the at least one region in the bitmap data.

36. The method of claim 35 wherein the bitmap data is provided with the descriptive information to the encoder via the general API, without including the bitmap data in a rasterized page bitmap.

37. The method of claim 35 wherein the bitmap data is provided in a rasterized page bitmap.

38. The method of claim 35 wherein the type of data in the at least one region is determined from the descriptive information, and wherein the type is used to select one of a plurality of available compression formats for the encoding, wherein each available compression format is suitable for a particular type of data.

39. The method of claim 38 wherein the at least one region includes text data, and wherein the encoding includes:
constructing a symbol dictionary by extracting at least one shape from the bitmap data, and
comparing the bitmap pattern of each shape with shape bitmaps already stored in the symbol dictionary to determine if each extracted shape bitmap is already stored in the dictionary; and
storing an extracted shape bitmap in the symbol dictionary if that shape bitmap is not already stored therein.

40. The method of claim 38 wherein the bitmap data includes character bitmaps, wherein the character bitmaps are provided to the encoder without including the character bitmaps in a rasterized page bitmap.

41. The method of claim 38 wherein the descriptive information includes character identification information retrieved from the PDS data, wherein the character identification information includes character codes identifying characters in the PDS data, each character associated with one of the character bitmaps, and wherein the character identification information is provided to the encoder and used in the encoding.

42. The method of claim 38 wherein the type of data in the at least one region is image data that has previously been compressed using a previous compression format, and the descriptive information includes information describing the previous compression format, and further comprising converting the previously compressed image into a compressed image having an available compression formats for the encoding.

43. A method for rasterizing data to be encoded, the method comprising:
deriving descriptive information from print data stream (PDS) data, the PDS data describing output for an output device, wherein the descriptive information includes a description of at least one text region of data in the PDS data;
rasterizing the PDS data into additional descriptive information including bitmap data depicting the at least one text region, wherein the bitmap data is not included in a rasterized page bitmap of the PDS data; and
providing the descriptive information and the additional descriptive information to an encoder so that the encoder can use the descriptive information when encoding the bitmap data into compressed data, wherein the descriptive information is used to determine a compression format suitable for the at least one text region depicted by the bitmap data.

44. The method of claim 43 wherein the bitmap data includes a plurality of individual character bitmaps, each representing a character in the at least one text region of data, and wherein the descriptive information includes text placement information describing the positions of the individual character bitmaps within an output page.

45. The method of claim 44 wherein the descriptive information includes character identification information retrieved from the PDS data, wherein the character identification information is to be used in the encoding, wherein the character identification information includes character codes identifying characters in the PDS data and font codes associating characters with the character bitmaps.

46. The method of claim 43 further comprising:
deriving non-text descriptive information from the PDS data, the non-text descriptive information including a designation of at least one non-text region of data in the PDS data;
rasterizing the at least one non-text region of data into non-text bitmap data; and
encoding the non-text bitmap data into non-text compressed data, wherein the designation of the at least one non-text region is used in the encoding to determine a compression format suitable for the at least one non-text region of data.

47. The method of claim 43 wherein the descriptive information is provided to the encoder via an application program interface (API).

48. A rasterizer for facilitating the encoding of data, the rasterizer comprising:
means for deriving descriptive information from print data stream (PDS) data, the PDS data describing output for an output device, wherein the descriptive information includes a description of at least one text region of data in the PDS data;
means for rasterizing the PDS data into additional descriptive information including bitmap data depicting the at least one text region, wherein the bitmap data is not included in a rasterized page bitmap of the PDS data; and
means for providing the descriptive information and the additional descriptive information to an encoder so that the encoder can use the descriptive information when encoding the bitmap data into compressed data, wherein the descriptive information is used to determine a compression format suitable for the at least one text region depicted by the bitmap data.

49. A computer readable medium including program instructions to be implemented by a computer, the program instructions for rasterizing data to be encoded, the program instructions implementing steps comprising:
deriving descriptive information from print data stream (PDS) data, the PDS data describing output for an output device, wherein the descriptive information includes a description of at least one text region of data in the PDS data;
rasterizing the PDS data into additional descriptive information including bitmap data depicting the at least one text region, wherein the bitmap data is not included in a rasterized page bitmap of the PDS data; and
providing the descriptive information and the additional descriptive information to an encoder so that the encoder can use the descriptive information when encoding the bitmap data into compressed data, wherein the descriptive information is used to determine a compression format suitable for the at least one text region depicted by the bitmap data.

50. The computer readable medium of claim 49 wherein the bitmap data includes a plurality of individual character bitmaps, each representing a character in the at least one text region of data, and wherein the descriptive information includes text placement information describing the positions of the individual character bitmaps within an output page.

51. The computer readable medium of claim 50 wherein the descriptive information includes character identification information retrieved from the PDS data, wherein the character identification information is to be used in the encoding, wherein the character identification information includes character codes identifying characters in the PDS data and font codes associating characters with the character bitmaps.

52. The computer readable medium of claim 49 further comprising:
deriving non-text descriptive information from the PDS data, the non-text descriptive information including a designation of at least one non-text region of data in the PDS data;
rasterizing the at least one non-text region of data into non-text bitmap data; and
encoding the non-text bitmap data into non-text compressed data, wherein the designation of the at least one non-text region is used in the encoding to determine a compression format suitable for the at least one non-text region of data.

53. A method for encoding data, the method comprising:
receiving descriptive information from a rasterizer, the descriptive information derived from print data stream (PDS) data describing output for an output device, wherein the descriptive information includes a description of at least one text region of data in the PDS data and bitmap data depicting the at least one text region of data, wherein the bitmap data is not included in a rasterized page bitmap of the PDS data; and
encoding the bitmap data into compressed data, wherein the descriptive information is used in the encoding to determine a compression format suitable for the bitmap data depicting the at least one text region of data.

54. The method of claim 53 wherein the bitmap data includes a plurality of individual character bitmaps, each representing a character in the at least one text region of data, and wherein the descriptive information includes text placement information describing the positions of the individual character bitmaps within an output page.

55. The method of claim 54 wherein the encoding includes:
constructing a symbol dictionary by comparing each character bitmap with character bitmaps already stored in the symbol dictionary to determine if the received character bitmap is already stored in the dictionary, and
storing a character bitmap in the symbol dictionary if that character bitmap is not already stored therein.

56. The method of claim 54 wherein the descriptive information includes character identification information retrieved from the PDS data, wherein the character identification information is used in the encoding and includes character codes identifying characters in the PDS data and font codes associating characters with the character bitmaps.

57. The method of claim 56 wherein the encoding includes:
constructing a symbol dictionary by comparing each particular character code with character codes already stored in the symbol dictionary to determine if the character bitmap associated with the particular character code is already stored in the dictionary, and
storing a character bitmap in the symbol dictionary if the associated particular character code is not already stored therein.

58. The method of claim 53 wherein the descriptive information is received from the rasterizer via an application program interface (API).

59. The method of claim 53 wherein the encoding is performed using the multi-region compression toolkit JBIG2.

60. An encoder for encoding data, the encoder comprising:
means for receiving descriptive information from a rasterizer, the descriptive information derived from print data stream (PDS) data describing output for an output device, wherein the descriptive information includes a description of at least one text region of data in the PDS data and bitmap data depicting the at least one text region of data, wherein the bitmap data is not included in a rasterized page bitmap of the PDS data; and
means for encoding the bitmap data into compressed data, wherein the descriptive information is used to determine a compression format suitable for the bitmap data depicting the at least one text region of data.

61. A computer readable medium including program instructions to be implemented by a computer, the program instructions for encoding data, the program instructions implementing steps comprising:
receiving descriptive information from a rasterizer, the descriptive information derived from print data stream (PDS) data describing output for an output device, wherein the descriptive information includes a description of at least one text region of data in the PDS data and bitmap data depicting the at least one text region of data, wherein the bitmap data is not included in a rasterized page bitmap of the PDS data; and
encoding the bitmap data into compressed data, wherein the descriptive information is used in the encoding to determine a compression format suitable for the bitmap data depicting the at least one text region of data.

62. The computer readable medium of claim 61 wherein the bitmap data includes a plurality of individual character bitmaps, each representing a character in the at least one text region of data, and wherein the encoding includes:
constructing a symbol dictionary by comparing each character bitmap with character bitmaps already stored in the symbol dictionary to determine if the received character bitmap is already stored in the dictionary, and
storing a character bitmap in the symbol dictionary if that character bitmap is not already stored therein.

63. The computer readable medium of claim 61 wherein the bitmap data includes a plurality of individual character bitmaps, and wherein the received descriptive information includes character identification information that includes character codes identifying characters in the PDS data, each character code associated with one of the character bitmaps, and wherein the encoding includes:
constructing a symbol dictionary by comparing each particular character code with character codes already stored in the symbol dictionary to determine if the character bitmap associated with the particular character code is already stored in the dictionary, and
storing a character bitmap in the symbol dictionary if the associated particular character code is not already stored therein.

64. The computer readable medium of claim 61 wherein the descriptive information is received from the rasterizer via an application program interface (API).
